(19) United States
(12) Patent Application Publication
(10) Pub. No.: US 2004/0267868 A1
(43) Pub. Date: Dec. 30, 2004

(54) Method for monitoring print jobs in a data processing network

(75) Inventor: Tomasz Franciszek Wilk, Cary, NC (US)

Correspondence Address: LALLY & LALLY, L.L.P., P. O. BOX 684749, AUSTIN, TX, 78768-4749, US

(73) Assignee: International Business Machines Corporation, Armonk, NY (US)

(21) Appl. No.: 10/606,697

(22) Filed: Jun. 26, 2003

(51) Int. Cl. G06F 15/16

(52) U.S. Cl. 709/200

(57) ABSTRACT

A network includes network connected printers and print clients. Each print client permits users to submit print jobs to the printers. A first print job table stored within the network contains information indicating the printer capacity available to each user. Computer code determines whether to accept a new print job based on a comparison of the capacity required to process the job and the user's available printer capacity. Available capacity information indicates the difference between a print quota associated with the user and the remaining size of all pending print jobs submitted by the user. The network further includes code for updating the available capacity information either indirectly by periodically adjusting the available capacity information of each user based on an approximation of the amount of print processing that has occurred or directly by determining the actual amount of capacity required to process the user's pending print jobs.

### BACKGROUND

1. Field of the Present Invention

The present invention is related to the field of data processing networks and, more particularly, to shared printers on such networks.

2. History of Related Art

In many networked environments, a potentially large number of users or clients must share relatively scarce resources including scarce input/output (I/O) resources including the network's printer(s). In academic, research, business, and other familiar environments, users often send incorrect print jobs to a printer, send very large print jobs to limited capacity printers, and so forth. The net effect of such commonly encountered activity is to overload the printer resources thereby making them effectively unavailable and to waste large amounts of consumable and potentially expensive resources including paper and printer cartridges. It would be desirable to implement a system for effectively monitoring print jobs in a network environment to prevent users from intentionally or unintentionally monopolizing printer resources and using large amounts of paper and ink.

### SUMMARY OF THE INVENTION

The goal stated above is achieved according to the present invention by a data processing network that includes one or more printers and a set of network connected print clients. Each print client permits a user to submit a print job to one of the printers. A first print job table stored within the network contains information indicative of the printer capacity available to each user. The network includes computer code for determining whether to accept a new print job submitted by a user based on a comparison of the capacity required to process the new print job and the user's available printer capacity. The available capacity information is indicative of the difference between a print quota associated with the user and the remaining size of all pending print jobs submitted by the user. The network further includes code for updating the available capacity information either indirectly by periodically adjusting the available capacity information of each user based on an approximation of the amount of print processing that has occurred since a previous period or directly by determining the actual amount of capacity required to process the user's pending print jobs.

### BRIEF DESCRIPTION OF THE DRAWINGS

Other objects and advantages of the invention will become apparent upon reading the following detailed description and upon reference to the accompanying drawings in which:

FIG. 1 is a block diagram of selected elements of a local area network on which the present invention might be suitably implemented;

FIG. 2 is a conceptual diagram of a table of print job information suitable for use in the present invention;

FIG. 3 is a flow diagram representing a method of monitoring print jobs in a networked environment according to one embodiment of the present invention; and

FIG. 4 depicts the monitoring of a particular user's print quota or capacity as the user submits jobs of differing sizes at different times.

While the invention is susceptible to various modifications and alternative forms, specific embodiments thereof are shown by way of example in the drawings and will herein be described in detail. It should be understood, however, that the drawings and detailed description presented herein are not intended to limit the invention to the particular embodiment disclosed, but on the contrary, the intention is to cover all modifications, equivalents, and alternatives falling within the spirit and scope of the present invention as defined by the appended claims.

### DETAILED DESCRIPTION OF THE INVENTION

The present invention is generally directed to a method and system in which print jobs are monitored in a networked environment to prevent monopolization of and improve access to printer resources and to prevent waste of consumable resources including printer paper. Print jobs submitted to a print server or directly to a printer on a local area network are checked against criteria to verify that the job is being submitted by an authorized user and that the user has not exceeded some predetermined print quota. If the job passes this screening, it is submitted to the printer for printing. If the screen detects the submission of a job that is excessively large or that a user is attempting to exceed his or her print quota, the job is rejected and the user must either submit the job to a printer with more capacity or wait until one or more previously submitted jobs are processed.

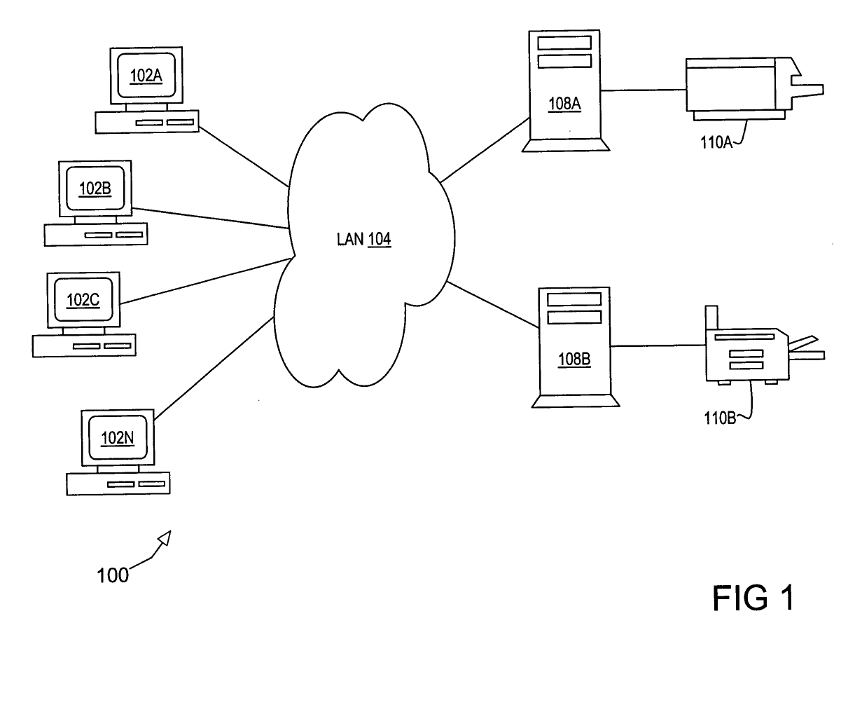

Referring now to the drawings, FIG. 1 is a block diagram of selected elements of a data processing network 100 suitable for implementing the present invention. In the depicted embodiment, data processing network 100 is a local area network (LAN) in which a set of print clients 102A, 102B, 102C through 102N (generically or collectively referred to as print client(s) 102) are connected to a LAN medium 104. Each print client 102 enables a user of a computer or other data processing device containing the print client to submit a print job to a printer connected to the network. The LAN medium 104 is likely an Ethernet compliant medium, but other LAN configurations, including token ring LANs as an example, are well within the scope of the invention.

LAN 100 as depicted in FIG. 1 includes a first printer 110A and a second printer 110B (generically or collectively referred to herein as printer(s) 110) both attached to the network via corresponding print servers 108A and 108B (generically or collectively referred to herein as print server(s) 108). To illustrate some features of the invention, first printer 110A is specified as having a different (lower) capacity than printer 110B. While the depicted embodiment illustrates distinct print servers 108A and 108B corresponding to each of the printers, other embodiments (not depicted) may employ a shared print server, in which a single print server supports multiple printers, and “direct” printers in which the printer is attached directly to the LAN media thereby bypassing a print server.

In LAN 100, any client 102 may submit a print job to a designated printer. If the submission of print jobs is not policed or otherwise monitored, beyond merely ensuring that the submitted print job does not exceed a printer buffer of the print server 108 or the printer 110, there exists the potential for one or more users to prevent or significantly limit the accessibility of the printer. Any client 102, for example might submit a print job having a size that would tie up the designated printer for some intolerable amount of time. Similarly, a user 102 might submit multiple jobs in quick succession again resulting in monopolization of the designated printer 110.

The present invention addresses the problems associated with substantially unregulated user access to scarce and shared I/O resources such as the LAN's printers 110. In one embodiment, print job information is maintained on a print server 108, a printer 110, or both to track the origin, size, and frequency of submitted print jobs. Using this print job information a printer 110, print server 108, or a combination of the two is able to recognize the submission of a job that exceeds either the printer's defined capacity or the client's print quota.

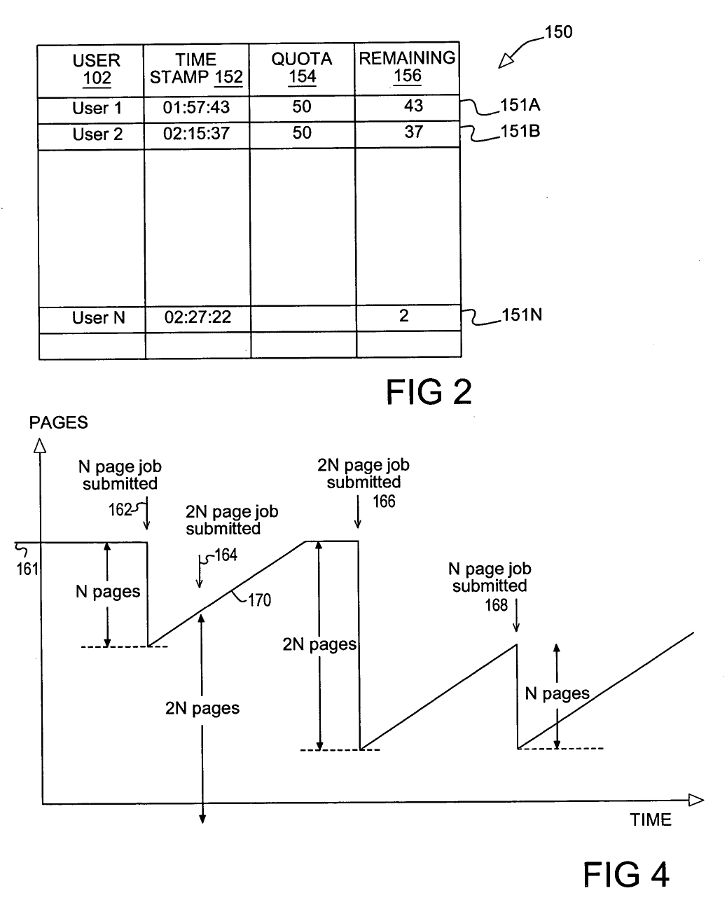

Referring now to FIG. 2, a conceptual representation of a table 150 of print job information stored in a data storage device within LAN 100 is depicted. In one embodiment, there is a print job table 150 corresponding to each printer 110. Each print job table(s) 150 may be stored in persistent memory of the corresponding print server 108 or, in other embodiments, directly within the printer 110. Generally, print job table 150 contains information that indicates whether the corresponding printer has available capacity to accept jobs by the various print client users. In the depicted embodiment, table 150 includes a set of entries 151A through 151N (generically or collectively referred to herein as entry/entries 151) where each entry 151 corresponds to a client or user 102. Print job table 150 as shown further includes timing information in the form of a time stamp 152 indicating the time when the corresponding entry of the print job table was created. Time stamp 152 likely indicates the time when a print job was submitted to the print server. Quota information 154 indicates the maximum amount of printer capacity that may be allocated to the corresponding user while the available capacity information 156 reflects how much of a user's maximum capacity is currently available. In some embodiments, all users or classes of users may have the same quota (i.e., the same maximum capacity). In an educational environment, for example, all student users may have the same assigned maximum print job capacity or quota. In such cases, Quota information 154 may be eliminated from table 150 to reduce the storage capacity required to hold table 150.

The number of entries 151 in the table may vary in at least two different ways. In one implementation of the invention, the table 150 is minimized in size by deleting entries when the corresponding user's available capacity is at its prescribed maximum or some other predetermined threshold. In other words, if a user 102 has all of its maximum printer capacity available, implying that any print jobs submitted by the user have been processed, the user's entry in table 150 may be deleted. In this embodiment, it will be appreciated therefore that table 150 reflects only those users who have submitted print jobs that are still pending or being processed by the designated printer 110 and print server 108. In an alternative implementation that is desirable for its ability to add a layer of security, print job table 150 may contain an entry for each authorized client of the corresponding printer resource. In this embodiment, the lack of an entry corresponding to a particular user indicates that the user is not currently authorized to use the printer and any job submitted to that printer by the user will terminate with an error message. In environments such as large universities or governmental organizations, however, the number of authorized users might render this latter implementation impractical.

Portions of the present invention may be implemented as a set or sequence of computer executable instructions (software) stored on a computer readable medium such as a magnetic disk, diskette, or tape drive, a CD ROM, a flash memory or other electrically alterable storage device or, during times when the software is being executed, a volatile storage device such as a computer's system memory (DRAM) or cache memory (SRAM).

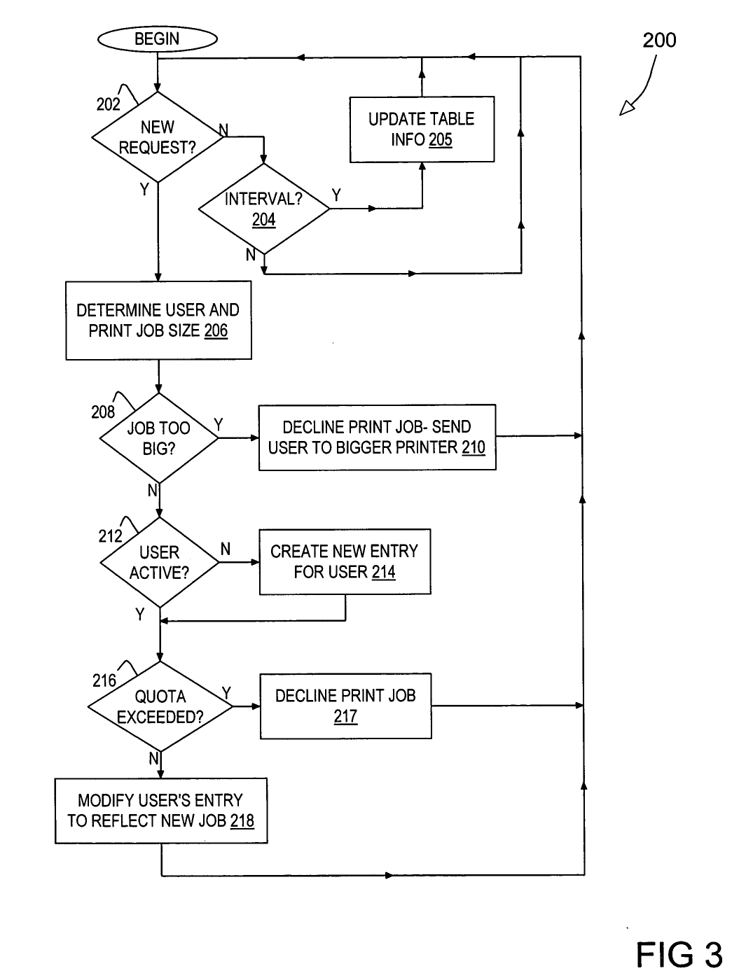

Referring to FIG. 3, a flow diagram illustrating a method 200 of monitoring print jobs in a data processing network employing shared print resources is presented. In the depicted embodiment, the print job monitoring method includes a monitoring step or determination (block 202) of whether any new print jobs have been submitted. If no new jobs have been submitted the print job information table may be updated to reflect progress (if any) made on pending print jobs. In the depicted embodiment, for example, the print job information in table 150 is updated based on a predetermined time interval. If table 150 has not been updated recently (i.e., it has been longer than the specified duration) as determined in block 204, the table is updated in block 205. Updating the table information may include updating the available capacity information 156 of each entry and eliminating entries for those users that no longer have a pending print job.

When a new print job request is encountered in block 202, the print server (or printer) determines (block 206) the print job's parameters. This process may include determining the user and the print job size. Depending upon its print capacity, each printer may have a predetermined maximum job size. If a new print job exceeds the maximum job size of the designated printer as determined in block 208, the print job is rejected and an error message is generated (block 210) informing the user to submit the job to a different printer with greater capacity. The maximum job size for each printer provides an absolute limit on the amount of pages that are acceptable to prevent a very large job submitted to a printer having a relatively low capacity from consuming all of the printer's availability.

Assuming that a new print job does not exceed the corresponding printer's maximum job size, the depicted implementation of method 200 then determines whether the user that submitted the job is an active user (block 212). In an embodiment in which print job table includes entries only for those users who have active or pending print jobs, active users are determined by consulting the list of users in print job table 150. If a new print job has been submitted by a user who has no pending print jobs, an entry 151 is created in table 150. If table 150 includes an entry for every authorized user whether a job is pending or not, the active user test in block 212 may be used to determine whether the user is authorized (this implementation of block 212 is not depicted).

Upon determining that a print job has been submitted by a user that does not currently have any pending print jobs, an entry 151 is created in table 150 to reflect the new job. According to the depicted embodiment, the new entry will include a time stamp 152 indicating the time the job was submitted and the user's available capacity. The available capacity is initiated to a value representing the difference between the size of the submitted print job and the user's quota. If, for example, the user submitting a print job has a 50 page quota and submits a 30 page print job, the available capacity for the user is initiated to a value of 20 pages to reflect that the user has used 30 of his or her 50 page quota.

If the print server determines in block 212 that a user who has submitted a new print job is an existing active user, the print server must then determine (block 216) whether the capacity required to process the requested print job will put the user over his or her quota. This determination is made by comparing the available capacity information 156 against the capacity required to process or the size of the newly submitted print job. If a user who has just 20 pages of available capacity submits a job in excess of 20 pages, the job will be rejected (block 217) and the user will be informed by an error message. If the size of the newly submitted print job together with the size of the user's pending print job(s) does not exceed the user's quota, the print job is accepted and the user's entry 151 in print job table 150 is modified to decrease the user's available capacity 156 by the size of the new print job.

Following the modification of a user's print job table entry 151 to reflect a new print job, processing continues as described above with the print server monitoring for new print jobs and updating the print job table 150 from time to time to reflect the partial or full completion of one or more jobs. Updating the print job table 150 in block 205 is achieved in a “direct” embodiment by tracking the actual number of pages remaining on the individual print jobs and updating the available capacity information 156 in table 150 to reflect this tracking information. In an indirect or approximated embodiment, the available capacity information 156 is updated from time to time based on the value of a clock or other timing device and a predetermined estimate of the printer's processing rate. In this embodiment, the print sever may assume a linear print processing rate such that the print server can adjust the available capacity information 156 based on the capacity available when the print job was submitted and the amount of time that has expired since the print job was submitted. In this indirect embodiment, the print server may periodically update the print job table 150 based on the amount of time that has elapsed and the capacity of the various printers. The time stamp information 152 in each entry 151 of table 150 is used (in conjunction with the current time) to estimate the amount of progress that has been made on the various pending print jobs. This embodiment beneficially eliminates some communication between the print server and the appropriate printer to determine the exact amount of progress that has been made while still enabling effective policing of print jobs by preventing one or a small number of users from consuming all of the system's printer bandwidth. In addition, the indirect embodiment is useful in preventing situations in which a user who has complied with his or her print quotas is penalized because of a problem beyond the user's control. If, for example, a user submits print jobs in compliance with the user's available capacity, but the selected printer is unable to make progress on the jobs due to no paper, a paper jam, low toner, etc., it may be desirable to permit the user to submit new jobs.

A conceptual illustration of the present invention is depicted in FIG. 4. In this illustration, the y-axis represents the size of a print job in pages (or some other indicator of job size such as bytes) while the horizontal access represents time and the graphed line 170 represents the available capacity information that is stored in the respective entries of print job table 150. Initially, (at time point 0 on the x-axis), the available capacity information 156 is set or initialized to the quota 161 for a particular user. The available capacity graph line is more or less flat until a first print job is requested as denoted by reference numeral 162. Print job 162 is an “N” page document and, accordingly, the available capacity line 170 is reduced by N pages and the available capacity information 156 corresponding to the user who submitted the job is altered to reflect the available capacity reduction.

The lower available capacity occurring after submission of first print job 162 prevents jobs of any significant size (page requirements) from being accepted. Gradually, as the user's print job(s) are completed or further processed, the user's available capacity increases and the available capacity information 156 is updated to reflect the increase. This gradual acquisition of additional capacity beneficially enables the submission of new jobs as soon as sufficient print capacity is available. The gradually increasing printer capacity is reflected by the slope of line 170. As mentioned above, the available capacity line may be updated directly based on the number of pages processed by the printer or indirectly by simply generating a line that approximates the restoration of print capacity or quota to each of the users.

As seen at reference numeral 164, a large print job is issued before the user's available print capacity is restored sufficiently to handle the large job. When the print server determines that the user submitting the large job does not have sufficient available print capacity, the job is rejected and an error message is generated. Eventually, either through the expiration of additional time (indirect restoration of print job capacity) or directly, the available capacity line 170 is restored sufficiently to enable the large (2N pages) print job to be submitted, as shown at reference numeral 166. The submission of this job reduces the available capacity line by 2N pages and then the capacity line is restored based on its rise time and so forth. FIG. 4 further shows the submission of an “N” page print job (reference numeral 168) at a time when the capacity on the appropriate printer is sufficient to accommodate the print job. The available capacity line drops N pages to reflect the size of the new print job and the process of restoring print capacity to others resumes. This demonstrates that acceptance of a new print job is possible as soon as the user has sufficient available print capacity to accommodate the job and that it is not required for the user to wait until the previously submitted job is completed.

It will be apparent to those skilled in the art having the benefit of this disclosure that the present invention contemplates a mechanism for policing print jobs in a networked environment. It is understood that the form of the invention shown and described in the detailed description and the drawings are to be taken merely as presently preferred examples. It is intended that the following claims be interpreted broadly to embrace all the variations of the preferred embodiments disclosed.

What is claimed is:

1. A data processing network, comprising:
a first printer connected to a network medium;
a set of print clients connected to the network medium, wherein each print client is enabled to permit a user to submit a print job to the first printer;
a first print job table to store information indicative of first printer capacity available to the user, the first print job table being stored in a computer readable medium; and
computer code means for determining whether to accept a new print job submitted by the user based on a comparison of the size of the new print job and the user's available first printer capacity.

2. The network of claim 1, wherein the available capacity information is indicative of the difference between a print quota associated with the user and the remaining size of all pending print jobs submitted by the user.

3. The network of claim 1, wherein the code means further includes code means for updating the available capacity information.

4. The network of claim 3, wherein the code means for updating the available capacity information includes code means for periodically adjusting the available capacity information of each user based on an approximation of the amount of print processing that has occurred since a previous period.

5. The network of claim 3, wherein the code means for updating the available capacity information is further characterized as code means for determining the actual amount of capacity required to process the user's pending print jobs.

6. The network of claim 3, wherein the code means for updating the available capacity information includes code means for deleting a first print job table entry corresponding to the user responsive to determining that the user's available first printer capacity is equal to or greater than a predetermined threshold.

7. The network of claim 1, wherein the first print job table includes an entry for every user authorized to submit print jobs to the first printer.

8. The network of claim 1, further comprising code means for rejecting a newly submitted print job if the size of the print job exceeds a predetermined maximum print job size associated with the printer.

9. The network of claim 1, further comprising a second printer connected to the network and available to the user for submitting print jobs and a second print job table to store information indicative of second printer capacity available to the user, the second print job table being stored in a computer readable medium.

10. The network of claim 1, further comprising a first print server connected between the network medium and the first printer, wherein the first print job table and the computer code means are stored in a storage medium of the first print server.

11. The network of claim 1, wherein the first print job table and the computer code means are stored in a storage medium of the first printer.

12. A computer program product comprising a set of computer executable instructions for managing print jobs within a data processing network, the instructions being stored in a computer readable medium, comprising:
computer code means for detecting the submission of a new print job to a first network connected printer by a user; computer code means for responding to the submission by determining the size of the new print job and rejecting the new print job if the size exceeds a maximum size corresponding to the first printer; and
computer code means for comparing the size of the print job to the first printer capacity available to the user and processing the print job based on the comparison, wherein the first printer capacity available to the user is indicative of the size of any pending first print jobs of the user.

13. The computer program product of claim 12, wherein the code means for comparing includes code means for accessing a first print job table containing a set of entries wherein each entry corresponds to a respective user and is indicative of the size of any pending print jobs submitted by the user.

14. The computer program product of claim 13, wherein the code means for comparing further includes code means for modifying the first print job table to reflect changes in the size of any pending print jobs submitted by the user.

15. The computer program product of claim 14, wherein the code means for modifying the first print job table includes code means for deleting a user's entry in the first print job table responsive to determining that the user's available capacity is equal to or greater than a threshold value.

16. The computer program product of claim 14, wherein the code means for modifying the first print job table to reflect changes in the size of any pending print jobs includes code means for estimating progress made on the pending print jobs based at least in part on the amount of time elapsed since submission of the print job.

17. A print job processing device for use in a data processing network, comprising: means for communicating with a set of print clients via a network medium to enable a user to submit a print job to a first network attached printer via the print job processing device;
a first print job table to store information indicative of first printer capacity available to the user, the first print job table being stored in a computer readable medium of the print job processing device; and
computer code means for determining whether to accept a new print job submitted to the first printer by the user based on a comparison of the size of the new print job and the user's available first printer capacity.

18. The print job processing device of claim 17, wherein the available capacity information is indicative of the difference between a print quota associated with the user and the remaining size of all pending print jobs submitted by the user.

19. The print job processing device of claim 17, wherein the code means further includes code means for updating the available capacity information.

20. The print job processing device of claim 19, wherein the code means for updating the available capacity information includes code means for periodically adjusting the available capacity information of each user based on an approximation of the amount of print processing that has occurred since a previous period.

21. The print job processing device of claim 19, wherein the code means for updating the available capacity information is further characterized as code means for determining the actual amount of capacity required to process the user's pending print jobs.

22. The print job processing device of claim 19, wherein the code means for updating the available capacity information includes code means for deleting a first print job table entry corresponding to the user responsive to determining that the user's available first printer capacity is equal to or greater than a predetermined threshold.

23. The print job processing device of claim 17, wherein the print job processing device is further characterized as the first network attached printer.

24. The print job processing device of claim 17, wherein the print job processing device is further characterized as a first print server connected between the first printer and the network.
